(19) United States
(12) Patent Application Publication
(10) Pub. No.: US 2013/0339101 A1
(43) Pub. Date: Dec. 19, 2013

(54) REQUEST FOR PROPOSAL AUTHORING

(71) Applicant: The One Page Company Inc., San Francisco, CA (US)

(72) Inventors: Patrick Riley, San Francisco, CA (US); Joanna Weidenmiller, San Francisco, CA (US); Stefan Proud, Sacramento, CA (US); John S. Bronson, San Francisco, CA (US); Stephane Come, Sacramento, CA (US)

(73) Assignee: The One Page Company Inc., San Francisco, CA (US)

(21) Appl. No.: 13/915,738

(22) Filed: Jun. 12, 2013

Related U.S. Application Data
(60) Provisional application No. 61/660,237, filed on Jun. 15, 2012.

(51) Int. Cl. G06Q 10/06

(52) U.S. Cl. CPC G06Q 10/0637
USPC 705/7.36

(57) ABSTRACT

Techniques and mechanisms described herein may facilitate the creation of a request for proposals. In some embodiments, user input for creating a document representing a request for proposals for a business action may be received. The user input may include information characterizing the business action. Suggested content to include in the document representing the request for proposals may be based on the received user input. The suggested content may describe the business action. The document representing the request for proposals may be created based on the received user input and the identified suggested content. The document may identify a business need and one or more criteria for responding to the request for proposals. The request for proposals may be stored on a storage medium.

### CROSS-REFERENCE TO RELATED APPLICATIONS

This application claims priority under 35 U.S.C §120 to Provisional U.S. Patent App. No. 61/660,237 (Atty. Docket No. ONEPP002P) by Riley et al., titled “Request for Proposal Authoring”, filed Jun. 15, 2012, which is hereby incorporated by reference in its entirety and for all purposes.

### TECHNICAL FIELD

The present disclosure relates to the field of personal and business planning and development, and more specifically to techniques and mechanisms for preparing various types of proposals for action.

### DESCRIPTION OF RELATED ART

Business plans and other types of project proposals are vital communication tools in the business world. Companies and individuals must be able to plan potential projects and subsequently communicate these plans in a clear and coherent manner to potential investors and partners. This is often done in the form of a written document outlining and detailing the key elements of the project.

Although clear communication is important, time is also often critical in making business decisions. A proposal or plan may be comprehensive, but too cumbersome and lengthy to read thoroughly. A person may not have time to digest all of the material. Key information can become lost in verbiage and overlooked. As a result, a proposal may be rejected not for failing to be a viable idea, but because it was not communicated efficiently enough.

Establishing a business relationship is often a time-consuming, inefficient, and imprecise process. For instance, employers and job applicants often find it difficult to clearly define and communicate the employment needs of the company and the capabilities and ideas of the job applicant. Such difficulties cause problems such as unnecessary unemployment and suboptimal matches between employer and job applicants. Likewise, both individuals and organizations seeking to engage in relationships such as contracts for procurement or service often find it difficult both to succinctly and plainly describe the needs and abilities of each party and to locate the best business partner for the relationship.

### SUMMARY

Described herein are systems, methods, devices, and computer readable media that facilitate the creation of a request for proposals. In some embodiments, user input for creating a document representing a request for proposals for a business action may be received. The user input may include information characterizing the business action. Suggested content to include in the document representing the request for proposals may be based on the received user input. The suggested content may describe the business action. The document representing the request for proposals may be created based on the received user input and the identified suggested content. The document may identify a business need and one or more criteria for responding to the request for proposals. The request for proposals may be stored on a storage medium.

In some embodiments, the document representing the request for proposals fits on a single page. Creating the document representing the request for proposals may include organizing and formatting the user input and the identified suggested content to fit on the single page.

In some embodiments, receiving the user input may include receiving answers to one or more structured questions related to the request for proposals. The business action may include an employment opportunity. The identified suggested content may describe the responsibilities associated with the employment opportunity.

In some embodiments, the user input may identify an industry context associated with the business action. The suggested content may include information related to the identified industry context. Creating the document representing the request for proposals may include providing access to an interactive document editing system configured to create and update the document based on user interaction.

In some embodiments, the interactive document editing system may be configured to present a preconfigured template for creating the document. The preconfigured template may be selected based on the received user input.

In some embodiments, the document representing the request for proposals may be transmitted to one or more recipients via a network. Each of the recipients may be invited to review the request for proposals or to submit a proposal in response to the request for proposals.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

The disclosure may best be understood by reference to the following description taken in conjunction with the accompanying drawings, which illustrate particular embodiments.

FIG. 1 illustrates an example of a method for authoring a request for proposals in accordance with techniques and mechanisms described herein.

FIGS. 2 and 3 illustrate examples of a system that may be used in accordance with techniques and mechanisms described herein.

FIG. 4 illustrates an example of a method for creating a request for proposals.

FIG. 5 illustrates an example of a method for editing a request for proposals.

FIG. 6 illustrates an example of a method for publishing a request for proposals.

FIGS. 7-10 illustrate examples of a system that may be used in accordance with techniques and mechanisms described herein.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, some of the techniques of the present invention will be described in the context of proposal documents, such as proposal documents related to employment opportunities. However, it should be noted that the techniques of the present invention apply to a wide variety of different documents and communications. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Techniques and mechanisms described herein facilitate the creation and publishing of requests for proposals (RFPs) by users acting as individuals or representing organizations. The RFPs may then be published and viewed by or transmitted to interested recipients. The recipients may then create proposals in response to the RFPs. A proposal system for facilitating the creation of RFPs and proposals generated in response to RFPs may facilitate various types of business transactions.

According to various embodiments, a proposal system may provide a platform for companies to publish RFPs for open positions or projects to be filled. The proposal system may provide a platform for job seekers to create and submit proposals or ideas in response to open RFPs. The proposal system may facilitate the gathering of statistics and analytics, such as information related to employment or company performance. The proposal system may facilitate the development of new techniques for matching business partners with each other, employees with employers, and problems with solutions.

Example Embodiments

According to various embodiments, a proposal system may provide assistance to a user creating an RFP on behalf of an entity. For example, the proposal system may suggest content for including in an RFP. As another example, the proposal system may assist the user with formatting the RFP. As yet another example, the proposal system may help the user elicit reviews of the RFP by other individuals. As still another example, the proposal system may facilitate the publication of the RFP and the transmission of the RFP to recipients. By guiding the user in a process to create an RFP, the proposal system may help ensure that the RFP more accurately describes the needs and qualities of the entity creating the RFP.

According to various embodiments, authoring and submitting a proposal for employment may offer various advantages to job applicants in comparison with sending a traditional resume. For example, a proposal may allow a job applicant to present a compelling case for a company to hire the applicant. The proposal may be used to show the prospective employer exactly how the applicant will make the company better and more successful. By presenting the applicant in a way that an ordinary resume can't accomplish, a proposal may significantly increase the applicant's chances of landing a job. Creating a proposal may also help give the applicant helpful insights into the applicant's unique personal qualities and life experiences, which may help the applicant better stand out as a job candidate.

According to various embodiments, authoring an RFP and receiving proposals for employment may offer various advantages to organizations in comparison with traditional postings on job boards or other mechanisms and techniques to alerting prospective job applicants to employment opportunities. Traditional recruitment typically involves resumes. While resumes often provide information regarding personal data and a candidate's experience and knowledge, resumes typically provide little detail regarding the candidate's mindset and attitude. In contrast to resumes, proposals created in accordance with the techniques described herein may be used to evaluate a candidate's abilities in comprehension, analysis, synthesis, and evaluation. In order to solicit proposals, a company may create a request for proposals that describe the challenges and needs facing the organization. Then, the company will receive a proposal from each job applicant that describes exactly how that job applicant plans to solve the challenges and fulfill the needs described in the RFP.

According to various embodiments, a proposal may include designated content sections, which may appear in a designated order. For example, a proposal may include Title and/or Subtitle sections that define the proposal, Target and/or Secondary Target sections that identify the goals of the proposal, a Rationale section that lays out the basic reasons why the action is necessary, a Financial section that describes the financial aspects of the deal, a Status section that describes a current state of affairs, and/or an Action section that indicates exactly what the proposer wants the recipient to do.

In some cases, the discussion of embodiments herein refers to proposals and RFPs authored and processed for the purposes of connecting job applicants with potential employers. However, according to various embodiments, the techniques and mechanisms discussed herein may be used to facilitate a wide variety of business transactions and relationships. These transactions and relationships may include, but are not limited to, employment opportunities, procurement contracts, service agreements, consulting arrangements, and legal representation.

According to various embodiments, a proposal and/or an RFP may be created in accordance with a designated format. In particular embodiments, the format may limit both each proposal and each RFP to a single page. Accordingly, some embodiments discussed herein and illustrated in the drawings may refer to a one page proposal. However, various types of formats and restrictions on proposals and RFPs may be used. For example, proposals and/or RFPs may be limited to a different length. As another example, proposals and/or RFPs may be created in accordance with restrictions on the type and order of content included in each document. As yet another example, in some embodiments formatting characteristics such as content or length may serve as guidelines rather than strict limits. In some embodiments, the types of formats and restrictions used may be strategically determined based on factors such as the type of information conveyed by the communications and the type of industry in which the communications are conducted.

According to various embodiments, the infrastructure for providing a proposal system may be configured in various ways. In particular embodiments, the infrastructure may be provided via a cloud computing framework. In a cloud computing framework, hardware and basic software such as web server software may be provided in a scalable, on-demand fashion by a third-party, while the service provider of the proposal system provides the application logic and other high-level functionality for generating the proposal system. Alternately, the infrastructure may be provided via a more conventional computing framework, for example a computing framework in which the hardware and/or basic software for providing access to the system is controlled by the service provider of the proposal system.

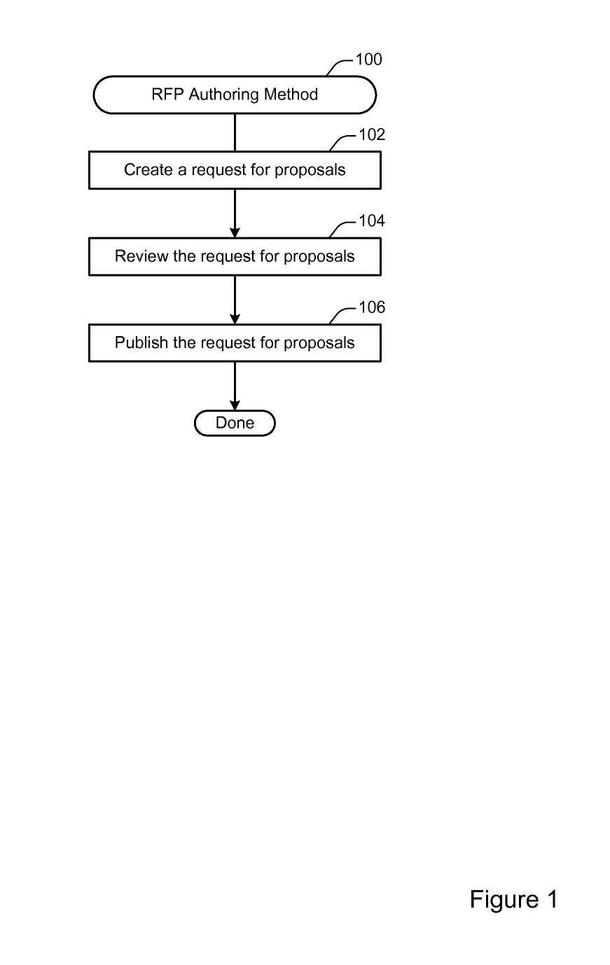

FIG. 1 shows an example of a method 100 for authoring an RFP. According to various embodiments, the method 100 may be used to help the user create an RFP that best describes the needs and qualities of the business entity represented by the user. The user may access the proposal system to create an RFP, receive guidance for creating content to include in the RFP, solicit feedback regarding the RFP from other individuals, and publish the RFP.

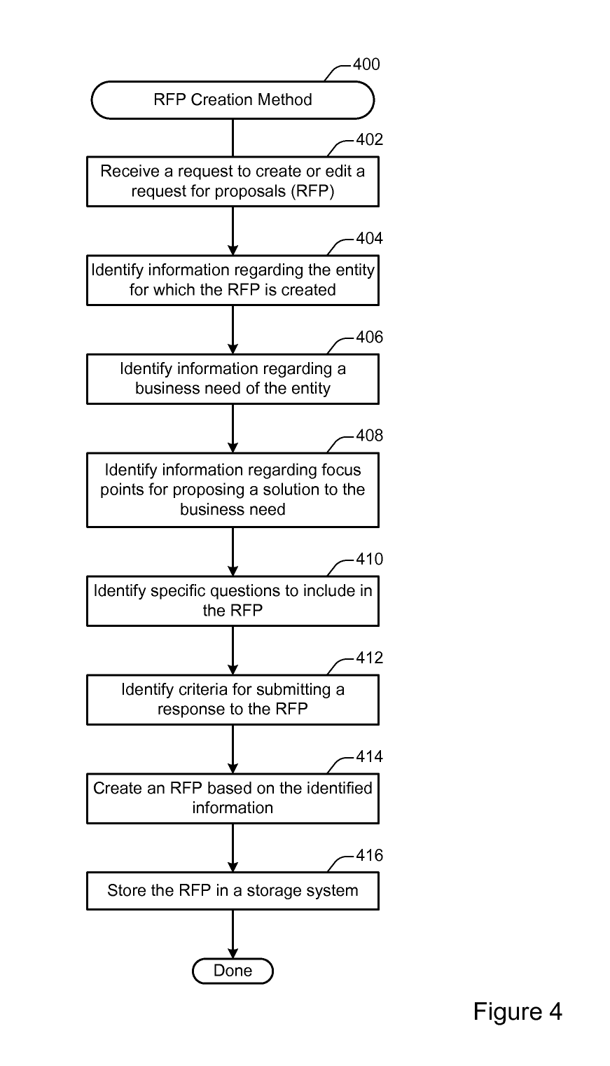

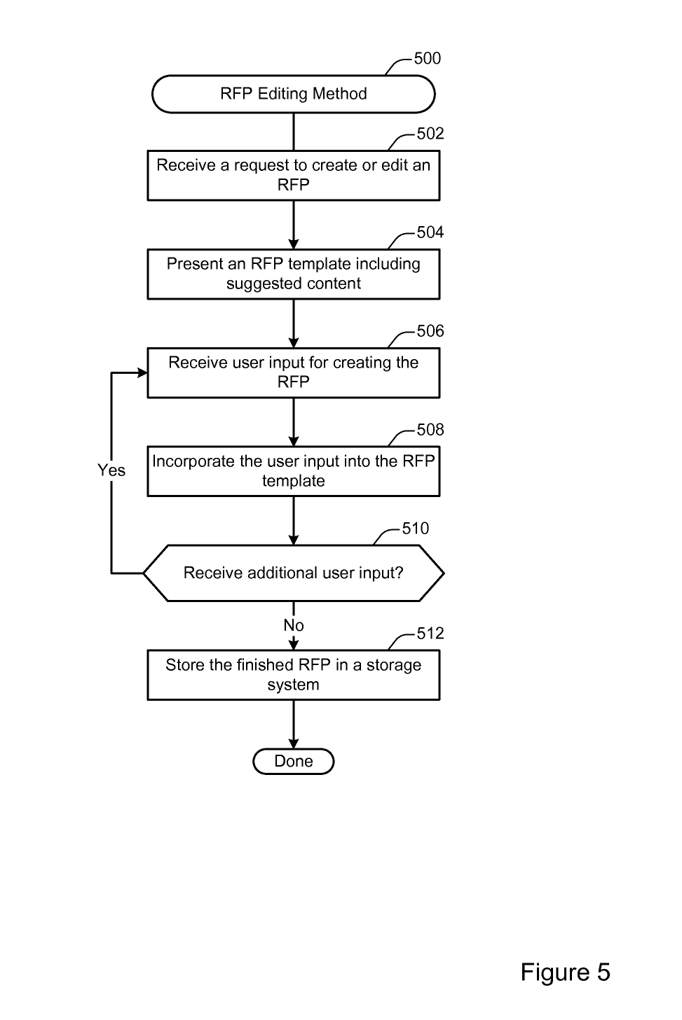

At 102, a request for proposals is created. Creating the RFP may involve combining user input with content suggested by the proposal system in a user interface. The proposal system may assist the user with selecting and presenting the content in a designated format. Techniques for creating and editing an RFP are discussed in additional detail with respect to FIGS. 4 and 5.

At 104, the RFP is reviewed. According to various embodiments, reviewing the RFP may involve identifying other users who may provide useful feedback regarding the RFP and sending those users an invitation to review the RFP. The feedback provided by the reviewers may be incorporated into the RFP or stored along with the RFP. In this way, the business entity for which the RFP is created may have a record of the entire transaction and may involve various interested parties in the creation of the RFP.

At 106, the request for proposals is published. According to various embodiments, publishing the RFP may involve storing various information related to the RFP and transmitting the RFP to interested parties. Recipients of the RFP may be invited to submit a response in accordance with the criteria outlined in the RFP.

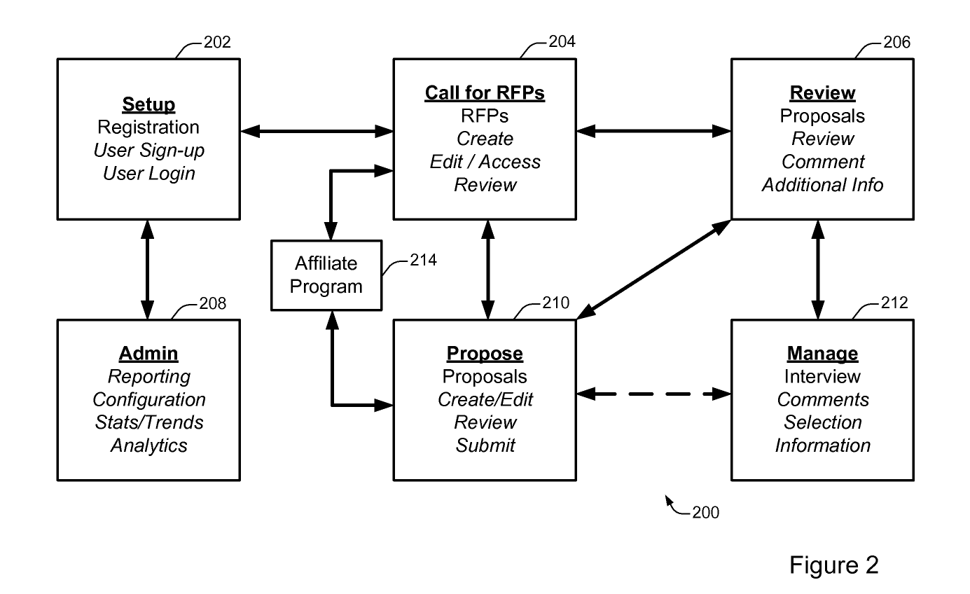

FIG. 2 shows a system 200 that may be used in accordance with techniques and mechanisms described herein. According to various embodiments, the system 200 may be used to generate, respond to, evaluate, transmit, receive, and administer proposals and requests for proposals (RFPs). The system 200 includes various modules for performing operations related to proposal generation and processing. These modules may be implemented on various computing devices in communication via a network. In particular embodiments, some modules may be implemented on the same computing device. Alternately, a module may be spread across more than one computing device.

The system 200 includes a setup module 202, an administration module 208, an RFP generation module 204, an RFP review module 206, a proposal generation module 210, a management module 212, and an affiliate program module 214. In some embodiments, a proposal system may include operations not shown in FIG. 2. Alternately, a proposal system may not include one or more of the modules shown in FIG. 2.

At 202, the setup module is shown. According to various embodiments, the setup module may facilitate the registration process for new users of the proposal system. The new users may be individuals, companies, or individuals working on behalf of companies. The new users may be creating RFPs, responding with proposals, or both.

According to various embodiments, the setup module 202 may also facilitate the login process for users who already have accounts. In order to log in to the proposal system 200, a user may need to provide identification information. The specific identification required may be strategically determined based on factors such as the degree of security desired, the capabilities of the client device from which the user is logging in, and the degree of convenience for the user. The type of information that may be requested from the user may include, but is not limited to: a user name, a password, a pass phrase, a personal identification number (PIN), a cryptographic certificate, or biometric information such as a fingerprint.

In some embodiments, the setup module may facilitate the registration process for new users by allowing users to log in through a third party account. For instance, a user may log in to a third party system such as LinkedIn, Facebook, or Gmail. Then, the third party service may transmit identification information for the user directly to the proposal system, for instance at the user's request. The transmitted identification information may be used to identify a previously created user account or may be used to register a new account within the proposal system. In particular embodiments, a user account within the proposal system and a user account within a third party system such as LinkedIn may be linked so that proposal-related actions may be integrated across the different systems.

According to various embodiments, user accounts may provide various features to users of the proposal system. For example, a user account may be associated with a profile that includes the user's email address and biographic data. A user account may be associated with a notification log that identifies notification messages by or to the user such as emails, Twitter messages (tweets), text messages, and messages sent via the proposal system. A user account may allow the display of a user interface for displaying activity metrics such as a number of proposals created, a number of responses created, a number of views, and a number of jobs trending. A user account may be associated with a number of social media handles, such as Facebook, Twitter, and LinkedIn accounts. In particular embodiments, associating the accounts in this way may allow the user to publish proposals, requests for proposals, activity logs, and other status updates to the activity feeds of any one of the user's social networks, such as LinkedIn, Facebook, or Twitter. A user account may be associated with one or more groups of users or organization accounts.

At 204, an RFP generation module is shown. According to various embodiments, the RFP generation module may facilitate the creation, editing, and review of requests for proposals. Each request for proposal may be any request to receive proposed solutions to a problem facing an individual, company, or other entity. For example, an RFP may be a request to receive proposals for fulfilling an employment opportunity. As another example, an RFP may be a request to receive proposals for a service contract for a company. Using the RFP generation module 204, a user may create a new RFP, edit or view an existing RFP, or provide comments or otherwise review an RFP.

According to various embodiments, the RFP generation module 204 may include various components. For example, the RFP generation module may include a user interface component configured to receive information such as content to include in an RFP, formatting options for formatting an RFP, access policy options specifying access information such as who may view or edit an RFP, and other such information. As another example, the RFP generation module 204 may include a data management component for storing the data that makes up an RFP. As yet another example the RFP generation module 204 may include an RFP generation assistance component operable to help users create an RFP in a standardized, easily readable format. For instance, the RFP generation assistance component may analyze user input to help the user create an RFP with clear, readable prose constructed using well-understood terms and phrases. Also, the RFP generation assistance component may analyze the formatting of the RFP to help the user create a proposal that follows a standardized ordering or fits within a size or length constraint.

According to various embodiments, the RFP generation system may provide a user interface for accessing various types of features. For example, a user dashboard may list RFPs created and published by the user. Each RFP may be associated with information such as a description, a number of views, and a number of responses. In particular embodiments, the information presented in the user dashboard may be selected based on various types of user characteristics, such as a user's identity, access level, or organizational role.

According to various embodiments, an RFP upload interface may allow the uploading of an RFP or other content in a PDF or other document format. In particular embodiments, an RFP field generator may populate user information fields with biographical information or other data collected from uploaded documents in a PDF or other document format. For instance, the proposal system may scan or process the document in order to retrieve various types of information.

According to various embodiments, a proposal replies log may provide a list for displaying and reviewing proposals submitted in response to an RFP. Users may comment on each proposal publicly, privately, or semi-privately. A log may provide an interface to request, enter, and view RFP or proposal comments, interview feedback, proposal scores, and other types of information. A log may be presented as part of the user interface in the form of a dashboard displaying statistics concerning the RFP.

According to various embodiments, an RFP generation system may include one or more RFP tracking components. RFP tracking may include one or more user interfaces for displaying and reviewing different stages of the proposal generation, application, and review process. For instance, RFP tracking may include a user interface to view workflow status associated with an RFP. For example, a workflow status may indicate timing information such as a creation date, a period of time the RFP has been open, or a period of time remaining before the RFP is closed. As another example, a workflow status may indicate approval information such as whether an RFP has been approved or rejected, is pending review, or has been flagged as requiring revisions. As yet another example, a workflow status may indicate budgetary information such as whether the RFP has been budgeted, what budget has been allocated for the RFP, and in what time period the budgetary approval applies.

A proposal creator may include an interface such as one or more forms or wizards to help the user create, edit, review, and publish an RFP. An archiving interface may provide the ability to archive RFPs, proposals, and other documents. An interview manager may provide an interface to manage interviews, comments, proposal scores, and other such information. An interview invitation interface may provide the ability for a user viewing a proposal to send an invitation to the proposal creator or another individual to participate in an interview regarding the proposal. A proposal match interface may allow a user to select and display proposals matching criteria such as content criteria and scoring criteria.

At 206, a proposal review module is shown. According to various embodiments, the proposal review module may facilitate the review of proposals and/or RFPs. Reviewing a proposal or RFP may include viewing the proposal or RFP, providing comments regarding the proposal or RFP, or providing additional information for including with the proposal or RFP. In some instances, access to a proposal or RFP may be limited by an access policy, which may specify users or organizations who may take various actions related to a proposal or RFP.

In one example, a user may be a member of a company responsible for hiring a new employee. The user may then create a request for proposals for prospective applicants to describe how they would perform in the role of the new employee. In order to ensure that the RFP accurately describes the challenges that the company faces that led to the need to hire a new employee, the RFP may be reviewed by other individuals, such as the user's supervisor or a human resources manager at the company. These individuals may provide comments, suggest additional information for including in the RFP, or edit the RFP directly.

According to various embodiments, the proposal review module may facilitate the review of proposals provided in response to an RFP. For example, a prospective employee may create a proposal to fill an employment role at a company. Then, the prospective employee's friends or colleagues may be invited to critique the proposal before the prospective employee submits it. As another example, the author of an RFP may review proposals created in response to the RFP. When the author identifies suitable proposals, the author could initiate communications with the proposer or refer the proposal for further processing, such as an interview for a job candidate.

At 210, a proposal generation module is shown. According to various embodiments, the proposal generation module may facilitate the generation of proposals in response to an RFP created via the RFP generation module 204. The proposal generation module may allow a user to create a new proposal, edit an existing proposal, review or comment on a proposal, or submit a proposal to the creator of an RFP. As discussed with respect to the RFP generation module 204, the proposal generation module 210 may have various components, such as a user interface component, a data management component, or a proposal generation assistance component.

In some embodiments, the proposal generation module may be associated with a proposal tracking system configured to present various types of information related to a generated proposal. For example, the proposal tracking system may present information such as whether a proposal has been accepted or rejected, has been flagged as needing revisions, or is pending review. As another example, the proposal tracking system may indicate status information associated with a job-seeking candidate such as “rejected,” “hired,” “first phone screen”, or “first onsite interview,” or “in need of additional documentation or work samples.”

At 212, a proposal management module is shown. According to various embodiments, the proposal management module may facilitate the processing of proposals created via the proposal generation module 210. Processing may involve operations related to sorting, selecting, evaluating, and/or commenting on proposals.

For example, an RFP for an employment opportunity at a company may result in hundreds or thousands of proposals. In this case, an automated process associated with the management module 212 may be used to identify the most promising proposals. Then, those proposals may be further ranked or sorted by users, such as hiring managers at the company who access the proposals via the management module 212, to select a limited number of candidates for interviewing. Finally, the candidates selected for interviewing may be provided with a standardized interview process involving the management module 212 to reduce bias in the hiring process and to help identify the best candidate.

As another example, an RFP for a service contract may also generate many different proposals. These proposals may include a variety of information, such as proposed service contract terms. The management module 212 may be used to aggregate, sort, and analyze this information so that the proposed service contracts may be more easily compared. Next, the management module 212 may be used to identify proposals that meet designated criteria. Then, proposals that meet the designated criteria may be reviewed by individuals, who may work together to select a proposal for adoption.

At 208, the administration module is shown. According to various embodiments, the administration module may facilitate operations, which may include, but are not limited to: reporting, configuration, data analysis, and the determination of statistics or trends related to data accessible via the system. For example, the administration module may be used to create reports on how many RFPs or proposals have been created, which organizations are associated with the creation of RFPs or responses to RFPs, and who should be billed for services provided via the proposal system. As another example, the administration module may be used to configure the proposal system, such as establishing parameter values for logging into the system, registering new user accounts, creating RFPs, creating proposals, reviewing proposals, and managing proposals. As yet another example, the administration module may be used to analyze data accessible via the proposal system. For instance, the administration module may be used to identify trends in hiring by companies, statistics describing the types of jobs being created, or analysis of the types of problems facing companies.

According to various embodiments, the administration module may facilitate reporting and data analysis specific to an RFP or users associated with an RFP or open job position. For instance, a report may be generated regarding the demographic characteristics of applicants responding to a particular job posting. In some cases, companies may need to report on demographic data voluntarily submitted by applicants such as information regarding gender, race, veteran status, and disability status.

In some embodiments, a report may be generated regarding the activity log of users in the RFP process in order to track data such as time-to-hire, number of interviews scheduled, number of applicants, number of positions open by hiring manager, number of positions budgeted per quarter, and remaining open headcount. For example, the proposal system may track (e.g., for performance monitoring purposes) the activity log of recruiters or hiring managers. As another example, the proposal system may track the number of open positions per financial quarter, for instance for financial planning and forecasting purposes.

At 214, the affiliate program module is shown. According to various embodiments, the affiliate program module may be used to allow third party software or services to interact with the proposal system. For example, a company may wish to generate or receive RFPs and/or proposals in a specialized format or with specialized branding. In this case, an affiliate program or service may be employed to facilitate the production of the RFPs and/or proposals. As another example, a third party system may be used to distribute or promote an RFP, such as on an external social network.

According to various embodiments, the affiliate program module 214 may communicate with the rest of the system in various ways. In particular embodiments, the affiliate program module 214 may include a communication interface or API. In this case, the third party software or services may be located on remote systems and communicate with the proposal system via a network. Alternately, some or all of the third party software or services may be located on computing devices associated with the proposal system 200. In this case, the affiliate program module 214 may include one or more computing devices, such as application servers, under the control of the entity providing the proposal system.

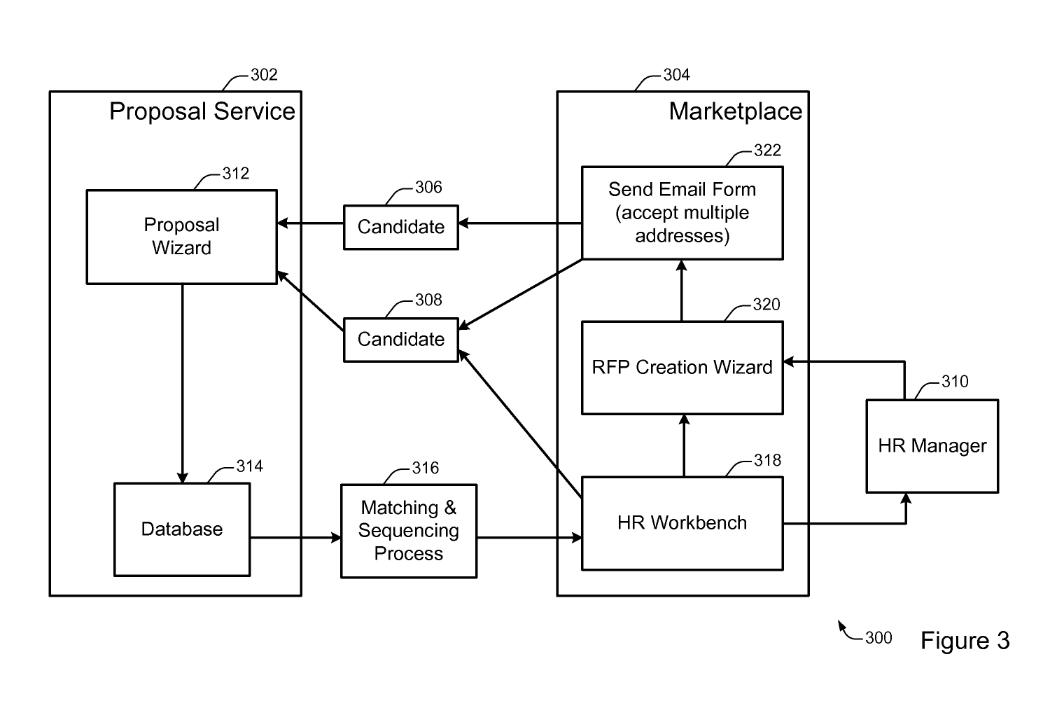

FIG. 3 shows a system 300 that may be used in accordance with techniques and mechanisms described herein. According to various embodiments, the system 300 may be used to create and respond to RFPs in the employment context. That is, the system 300 may facilitate the creation of requests for and responses to proposals to fulfill an employment need for a company.

The system 300 includes an applicant service provider (also referred to herein as a proposal service) 302 and a marketplace 304. The applicant service provider 302 includes modules operable to provide services to job applicants, such as a proposal creation wizard 312 and a storage system 314 such as a database. The marketplace 304 includes modules operable to provide services to companies, such as a human resources workbench module 318, an RFP creation wizard module 320, and a communication module 322. A proposal analysis module 316 may facilitate the transmission of information between the applicant service provider 302 and the marketplace 304. Various users, such as the job candidates 306 and 308 and the human resources manager 310 may interact with the system 300.

According to various embodiments, the marketplace 304 may allow users such as HR managers to create RFPs, to send RFPs to users, and to review proposals generated in response to RFPs. At 310, a human resources manager is shown interacting with the marketplace 304. The human resources manager may create an RFP via the RFP creation wizard 320. The RFP creation wizard 320 may be substantially similar to the RFP generation module 204 discussed with respect to FIG. 2.

According to various embodiments, when an RFP is created via the RFP creation wizard 320, one or more users may be invited to respond to the RFP via the communications module 322. The communications module 322 may facilitate the transmission of the RFP via various communications mediums. For instance, an invitation to respond to an RFP may be transmitted via email, instant message, text message, or communication via a social network such as LinkedIn, Twitter, or Facebook. As another example, an invitation to respond to an RFP or job posting may be posted to the company's or hiring manager's associated social network activity feed such as, but not limited to, a LinkedIn page, a Facebook page, or a Twitter account.

In particular embodiments, a user such as the human resources manager 310 may identify one or more recipients of the RFP via a list or other selection mechanism. Alternately, or additionally, the communications module 322 may assist the user in identifying recipients. For example, the communications module 322 may help the human resources manager 310 identify users of the proposal system who may be well-suited to submit a proposal in response to the RFP. As another example, the communications module 322 may identify recipients who have been sent similar proposals in the past or who have otherwise been previously designated for receiving such RFPs.

In the example shown in FIG. 3, the HR manager provides a list of e-mails to the communications module 322. Then, the communications module sends a message via e-mail to the job seekers 306 and 308. The message invites both candidates to submit a proposal in response to the RFP. The candidates 306 and 308 may create and submit such a proposal via the applicant service provider 302.

According to various embodiments, the applicant service provider may provide a number of business functions with accompanying user interfaces for job applicants to perform various operations. For example, the applicant service provider may provide a user dashboard that lists proposals created and submitted along with information such as a description of each proposal and a number of user views of each proposal. As another example, the applicant service provider may provide a proposal creator, which may include an interface containing one or more forms or guides to help the user create, edit, review, and publish a proposal. As yet another example, the service provider may provide a proposal replies log, which may allow users to list and review submitted proposals as well as to privately and/or publically comment on each proposal. As still another example, the service provider may provide an RFP browser that allows users to search, browse, and filter RFPs to identify open RFPs to which to respond.

According to various embodiments, the applicant service provider 302 is operable to provide various services to job seekers, such as the candidates 306 and 308. For example, a user may be able to view the number of recruiters who have viewed the applicant's proposals, a list of open RFPs in response to which the user is creating proposals, a list of comments that have been provided regarding the user's proposals, suggested edits to the user's proposals, and other such information. As another example, a user may be able to see a list of popular proposals or new features.

According to various embodiments, the proposal creation wizard 312 may be used to help create an appropriate response to the RFP. For example, the proposal creation wizard 312 may assist users in creating a proposal that includes content responsive to the RFP. As another example, the proposal creation wizard 312 may assist users in creating a proposal in accordance with a standardized format, such as content arranged in a particular order and/or content limited to a single page. The particular format and content associated with the proposal may be strategically determined based on factors such as the industry for which the proposal is created, the company to which the candidates are applying, the RFP to which the candidates are responding, and the type of information that is intended to be included in the proposal. The proposal creation wizard 312 may be in at least some respects substantially similar to the proposal generation module 210 discussed with respect to FIG. 2.

According to various embodiments, information received via the proposal wizard 312 may be stored in the storage module 314. The storage module 314 may include one or more databases, such as an Oracle database or a SQL database. The storage module may include various types of databases, such as a flat file database, a relational database, a cloud database, an active database, a distributed database, or any other type of database.

According to various embodiments, the information stored via the storage module 314 may include various types of information. For example, the storage module 314 may include raw data received via the proposal wizard 312. As another example, the storage module 314 may include completed proposals generated via the proposal wizard 312. As yet another example, the storage module 314 may include biographic information regarding the users who create proposals via the proposal wizard 312. The biographic information may include information such as names, ages, email addresses, sexes, mailing addresses, employment histories, information of the type normally included in resumes, or any other information.

According to various embodiments, after proposals are created, they may be analyzed via the proposal analysis module 316. The proposal analysis module 316 may perform various operations such as matching and sequencing the proposals. For example, the proposal analysis module 316 may identify RFPs in response to which a proposal may be submitted. As another example, the proposal analysis module 316 may evaluate or rank proposals to identify the best proposals submitted in response to an RFP. As yet another example, the proposal analysis module may annotate or otherwise comment on proposals.

According to various embodiments, the annotations, comments, rankings, evaluations, and/or analysis may be provided to the user who created the proposal, the company that receives the proposal, or any other user. In this way, users may receive feedback on their proposals, which may allow them to improve their proposals or identify other potential recipients of their proposals. Alternately, or additionally, recipients of the proposals may more easily identify the best proposals for adoption or for further sorting.

According to various embodiments, analyzed or processed proposals may be transmitted to companies for further evaluation. For example, proposals may be transmitted to the human resources workbench module 318. There human resources workbench may allow the proposals to be accessed or evaluated by users such as the human resources manager 310, other users within the company that generated the RFP, or users associated with third party entities such as companies who evaluate proposals or assist in the hiring process. For instance, the human resources manager 310 may review the proposals submitted to the human resources workbench module 318 and select proposals for further analysis or processing. In the example shown in FIG. 3, the human resources manager 310 selects the proposal created by the candidate 308. Then, the candidate 308 is sent a message containing an invitation to interview with the company. The operations performed via the human resources workbench module 318 may be at least in part substantially similar to the operations performed via the management module 212 discussed with respect to FIG. 2.

According to some embodiments, the evaluation of proposals may involve identifying one or more evaluators at a company responsible for evaluating the received proposal. Identifying an evaluator may involve designating an individual, a team, a computer program, or an organizational role responsible for reading and evaluating the proposal. The proposal system may facilitate the identification of an evaluator by name, email address, employee ID, department code, or any other designator. In particular embodiments, evaluators may be identified automatically, manually, or some combination thereof When an evaluator is identified, the proposal system may facilitate notifying the evaluator, for instance transmitting a message requesting that the evaluator evaluate the proposal.

According to various embodiments, the human resources workbench 318 may provide a user interface for viewing various types of information. for example, a user such as the human resources manager 310 may view information such as the number of candidates who have responded to an RFP, a number of days remaining for responding to an RFP or proposal, a list of new proposals submitted in response to RFPs, a list of comments to RFPs, and a number of direct messages transmitted via the proposal system. In particular embodiments, messages may be transmitted between any users or organizations registered with the proposal system.

According to various embodiments, the human resources workbench module 318 may facilitate further evaluation of the candidates who created proposals via the proposal wizard 312. For instance, the human resources manager 310 may select a number of the candidates for interviewing. Then, the human resources manager 310 may select or create a number of interview questions for posing to the selected candidates. The candidates may then be interviewed in various ways. For example, the candidates may receive the interview questions via email and provide responses to the human resources workbench module 318. As another example, the candidates may be interviewed by the human resources manager 310. As yet another example, the candidates may be interviewed by another entity such as an individual associated with a third party interview service or with the applicant service provider 302. The candidates responses may be stored, for instance via the human resources workbench module 318 and/or the storage module 314. In this way, the human resources manager 310 may analyze and evaluate the responses to select the best candidate.

FIG. 4 shows an example of a method 400 for creating an RFP in accordance with techniques and mechanisms described herein. According to various embodiments, the method 400 may be used to suggest information to a user for including in an RFP. The suggested information may be combined with user input to create an RFP that reflects the business needs of an entity and is presented in a designated format.

At 402, a request to create or edit a request for proposals (RFP) is received. According to various embodiments, the request may be received at a server operable to provide a proposal system. The request may be generated at client machine associated with a user acting on behalf of himself or on behalf of a business entity.

At 404, background information regarding the RFP is identified. In many instances, the RFP is a document associated with a business entity such as a company or other organization. Alternately, the entity may be an individual. Various types of information may be included in this background information. For example, the background information may include information describing the organization for which the RFP is created, such as a business industry with which the organization is associated, a location of the organization, a size of the organization, and the primary business of the organization. As another example, the background information may include information describing the user creating the RFP, such as the user's name and contact information. As yet another example, the background information may include a summary of the RFP, such as a brief description of the purpose for creating the RFP, and a deadline for responding to the RFP.

At 406, information regarding a business need of the entity is identified. In particular embodiments, the business need may identify any problem facing the organization for which the organization is seeking solutions via proposals. For example, the business need may be the filling of an employment position for a particular role within the organization. The employment position may be described in the context of a need to solve a particular problem, need, or project that the organization is facing. As another example, the business need may be a need for a service to be rendered to the organization by a service provider. As yet another example, the business need may be the provision of a particular type of product by a product vendor.

At 408, information regarding focus points for proposing a solution to the business need is identified. According to various embodiments, the focus points may be topics that any recipient of the RCP who wishes to submit a proposal in response should address in the proposal. For example, the focus points may identify proposed techniques or technologies for addressing the business need identified in operation 406. As another example, the focus points may be skills, abilities, credentials, experience levels, or certifications possessed by the individual or organization submitting the proposal that provide evidence of the proposer's ability to perform a proposed role or task. As yet another example, the focus points may be management or organizational strategies for integrating a proposed solution with the institutional framework of the organization.

At 410, specific questions to include in the RFP are identified. According to various embodiments, the questions identified in operation 410 may include any questions that the creator of the RFP wishes to ensure that a recipient explicitly responds to. For example, the recipient of the RFP may be asked whether he or she would relocate to accept an employment opportunity. As another example, the recipient may be asked why he or she would like to seek employment or otherwise engage in business with the organization with which the RFP is associated instead of some other entity. By including such explicit questions within the RFP, a proposal submitted in response to the RFP may be quickly evaluated to determine whether it includes appropriate responses to the identified questions.

At 412, one or more criteria for submitting a response to the RFP are identified. According to various embodiments, the criteria may identify any conditions or requirements for submitting a proposal. For example, the criteria may identify a timeline or deadline for responding to the RFP. As another example, the criteria may identify structural requirements for a proposal, such as sections that must be included within the proposal. As yet another example, the criteria may identify qualities or properties that should be possessed by the organization or individual who submits a proposal.

According to various embodiments, various techniques and mechanisms may be used to identify the information identified in operations 404-406. In some cases, the information may be retrieved from a company directory, website, database, or other electronic source of information about the organization with which the RFP is associated. In other instances, the information may be provided by the creator of the RFP. In yet other cases, the information may be retrieved from previously-created RFPs associated with the same business entity.

According to various embodiments, the method 400 may be used in conjunction with techniques for editing an RFP. In some cases, information discussed with respect to FIG. 4 may be identified by some combination of user input and suggestions by the proposal system. For instance, the proposal system may initially propose content for the sections discussed with respect to FIG. 4. Then, the user may enter information to replace or edit the proposed content. Techniques for combining user input with suggested content are discussed in further detail with respect to FIG. 5.

At 414, an RFP is created based on the information identified in operations 404-412. According to various embodiments, the RFP may be created by combining the identified information for presentation into a designated format. In some instances, the user may select formatting and presentation options. For example, the user may be presented with a graphical user interface in which the user can select the location in which text should be located. In other cases, the proposal system may select formatting and presentation options. For instance, the user may answer questions in a guide or wizard format, and the proposal system may combine the input to create the RFP after the user has provided the input.

In some embodiments, a user may select information such as an industry, category, or other characteristics for the RFP, for instance from a list or other user interface. Then, the RFP creation system may generate, populate, or otherwise create default formatting or content information based on the selected industry, category, or characteristic. For instance, sections or issues specific to an industry may be identified and used to pre-populate the RFP document in the editor. In this way, the proposal system may assist the user in constructing an RFP that reflects the user's preferences and goals.

According to various embodiments, the RFP may be created in an iterative fashion, with the user interface of the proposal system suggesting content to include in the RFP, incorporating user input into the RFP, and offering updated suggestions based on the user input. Techniques for editing an RFP in this fashion are discussed in additional detail with respect to FIG. 5.

At 416, the RFP is stored in a storage system. According to various embodiments, various information relating to the RFP may be stored. For example, a published version of the RFP may be stored, for example as a PDF document. As another example, the content suggested to the user creating the RFP may be stored. As yet another example, the content included in each section of the RFP may be separately stored.

FIG. 5 shows an example of a method 500 for editing an RFP. According to various embodiments, the method 500 may be used to combine user input with suggestions for content provided by the proposal system. For instance, the method 500 may be used to present suggested content to the user via a user interface and then receive user input editing or replacing the suggested content. The web browser may be presented to the user via a web browser operating on a computing device at a client machine, while the suggested content may be determined at a server associated with the proposal system.

At 502, a request to create and/or edit an RFP is received. According to various embodiments, the request may be received from a client machine associated with a user. In some cases, the request may be received as part of another procedure for creating an RFP. For instance, the request may be received in conjunction with operation 414 discussed with respect to FIG. 4.

At 504, an RFP template including suggested content is presented. According to various embodiments, the suggested content may include text, sections, or other such information that the proposal system has identified as a possibility for including in the RFP. Initially, the suggested content may be relatively generic content that simply provides an example to the RFP author of the type of content to include within an RFP. However, suggested content may also be retrieved based on the type of information discussed with respect to FIG. 4. For instance, if industry information is identified, then the suggested content may be updated to reflect the specific industry for which the RFP is created.

At 506, user input for creating the RFP is received. According to various embodiments, the user input may be any type of instruction for affecting the content or presentation of the RFP. For example, the user input may be the selection or designation of an option such as whether to include a particular section within the RFP. As another example, the user input may be additional text to include within the RFP. As yet another example, the user input may indicate or designate preferences for displaying the RFP. As still another example, the user input may indicate or designate a particular format to which the finished RFP should conform.

At 508, the user input is incorporated into the RFP template. According to various embodiments, the user input may replace the proposed content, modify the proposed content, or change the proposed content. In particular embodiments, text entered by the user may be marked differently than content suggested by the proposal system. For example, proposed content may be presented in a light gray font, while text entered by the user may be presented in a black font.

According to various embodiments, the proposal system may assist the user in incorporating the user input. For instance, the user may be provided with suggestions regarding a section in which to position text, how to format text, or how to combine text with suggested content.

According to various embodiments, updating the user input into the RFP may involve identifying new suggested content for presenting in the RFP template. When user input is received, such as user input identifying an industry, a job description, a technology, or other such information, the proposal system may analyze the information to update the selected content. In particular embodiments, the updated selected content may be identified and presented as the user is providing the user input. For instance, the template may be displayed in a user interface presented in a web browser at a client machine. As the user is entering content into the user interface, the web browser may transmit a message to a server to retrieve the updated content. Then, the content may be presented in the user interface without reloading the page.

At 510, a determination is made as to whether to receive additional user input. In particular embodiments, additional user input may be received until the user editing the RFP indicates that the RFP is complete. Alternately, or additionally, user input may be received until all of the fields or sections associated with the RFP are filled. In some cases, the RFP may be limited in length, for instance to a single page.

At 512, the finished RFP is stored in a storage system. According to various embodiments, the storage of the completed RFP at operation 512 may be substantially similar to the operation 416 discussed with respect to FIG. 4.

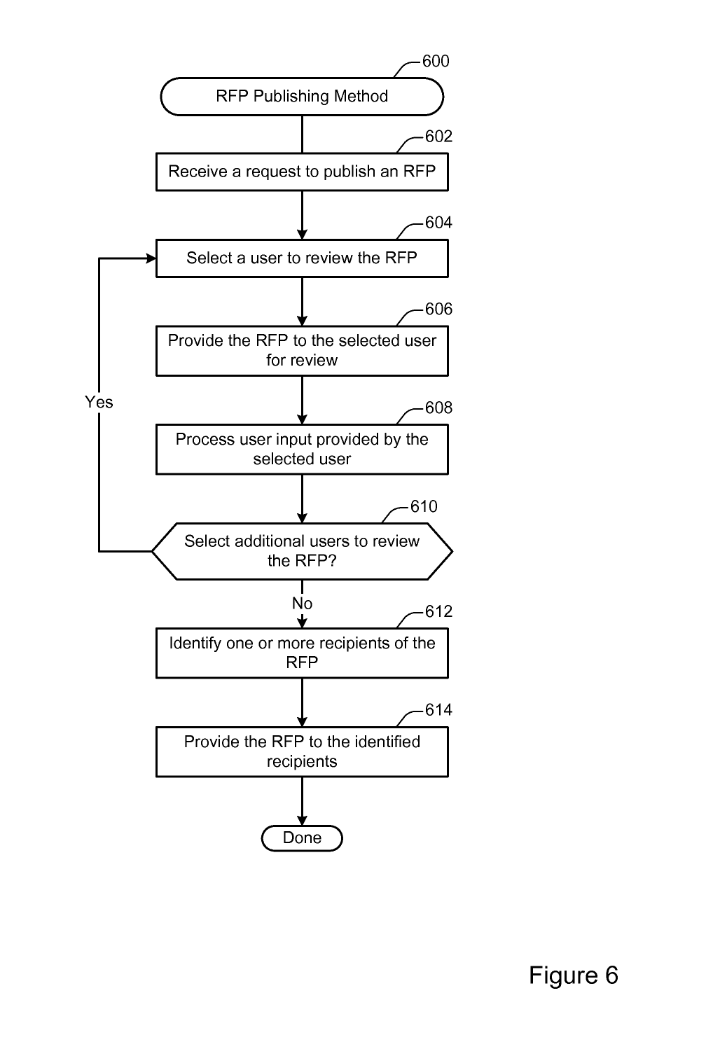

FIG. 6 shows an example of a method 600 for publishing an RFP, performed in accordance with techniques and mechanisms described herein. According to various embodiments, the method 600 may be used to solicit feedback or approval regarding an RFP, identify recipients of an RFP, and transmit the RFP to the identified recipients.

At 602, a request to publish an RFP is received. According to various embodiments, the request to publish the RFP may be received from a user when the user indicates that the RFP is complete. For instance, the request to publish the RFP may be received when the RFP information is stored at operation 512 discussed with respect to FIG. 5.

At 604, a user is selected to review the RFP. According to various embodiments, the user may be any individual whose input regarding the RFP is requested. For example, the user may be a supervisor, subordinate, peer, or other individual within an organization. As another example, the user may be a colleague, friend, or business partner of the individual creating the RFP.

At 606, the RFP is provided to the selected user for review. According to various embodiments, the RFP may be transmitted to the user in a message such as an e-mail. Alternately, or additionally, the user may be presented with a link for accessing the RFP via the proposal system.

At 608, user input provided by the selected user is processed. In particular embodiments, the user input may be suggested edits to the RFP or comments regarding suggested changes to the RFP. In this case, the user authoring the RFP may initiate an editing process to incorporate these suggestions into the RFP, as discussed with respect to FIG. 5.

In some embodiments, the user input may be a recommendation, approval, or endorsement of an RFP. For example, a supervisor or attorney may approve the RFP for publication or transmission to recipients. As another example, an individual such as an organization executive or president may endorse the RFP. Such an endorsement may provide an additional incentive for RFP recipients to present a thorough proposal in response. For example, if the CEO of a large company endorses an RFP, then a recipient of the RFP would know that the RFP describes business needs of particular importance to the company. As another example, an endorsement or recommendation by a company executive may indicate a particular focus or relevance of the RFP. For instance, if a chief financial officer or chief technical officer of a company endorses an RFP, then the recipient may be informed that the business needs described in the RFP may fall under the purview of the approving executive.

In particular embodiments, user input may be a “vote” or other such endorsement. Then, the votes from different users may be aggregated to determine a final score or outcome for the RFP. For example, an RFP may be approved when it receives a simple majority of a designated number of votes, when it receives a super-majority of a designated number of votes, or via any other voting arrangement.

At 610, a determination is made as to whether to select additional users to review the RFP. In particular embodiments, an RFP may need to be approved by a supervisor or by a designated number of peers within an organization before being published. Accordingly, additional users may continue to be selected until the designated number of approvals is received. Alternately, or additionally, users may continue to be selected until the RFP author indicates that a sufficient number of users have reviewed the RFP.

At 612, one or more recipients of the RFP are identified. According to various embodiments, the recipients may be identified via any technique for selecting or communicating with an individual. For instance, the author of the RFP may select or identify users via e-mail, via a social networking system such as LinkedIn, Twitter, or Facebook, via contact information included in a resume or application, or any other information.

According to various embodiments, the one or more recipients of the RFP may include individuals who previously submitted resumes to the organization. In such cases, a hiring manager or other individual at the organization may wish to receive additional information from the individual. However, as discussed herein, interviews and other mechanisms for communicating directly with the individual may sometimes be relatively resource-intensive, subjective, and inefficient. Accordingly, the individual may first be invited to submit a proposal in response to an RFP. While a resume tends to be a static document that focuses on previous achievements and accomplishments of the applicant, the proposal submitted in response to the RFP should be a dynamic, forward-thinking document that describes how the applicant would solve the particular problems and business needs facing the organization. In this way, the organization can request and receive more interesting, actionable information about the applicant with a minimal expenditure of resources.

At 614, the RFP is provided to the identified recipients. According to various embodiments, the RFP may be provided via any technique for communicating with the recipients. For instance, as discussed with respect to operation 612, a recipient may be identified via any of various communications mediums. Accordingly, if a recipient is identified via e-mail or a social network such as LinkedIn, then the RFP may be transmitted to the recipient via an e-mail or a message transmitted via the social network system.

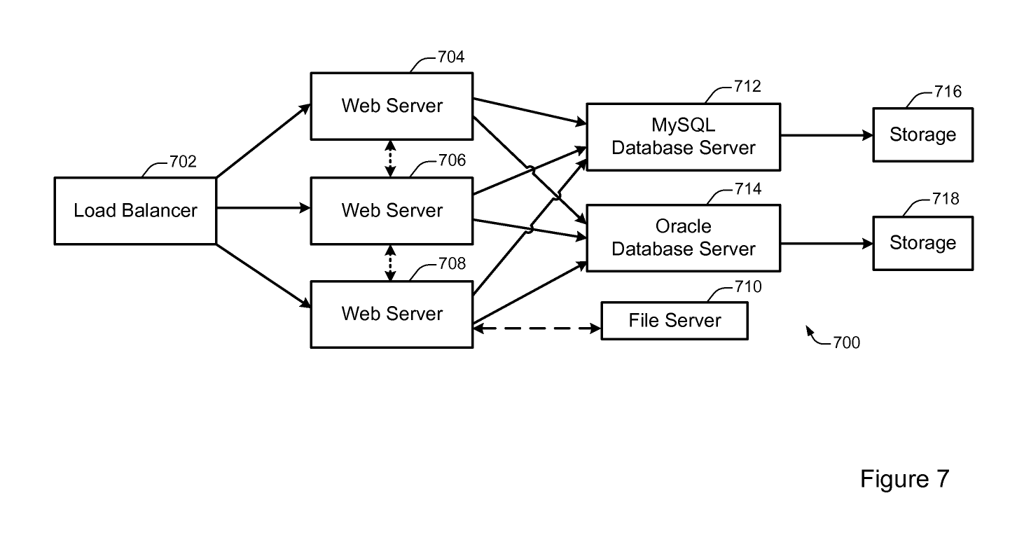

FIG. 7 shows one example of a system 700 that may be used in accordance with techniques and mechanisms described herein. The system 700 represents the conceptual architecture of at least a part of the proposal system, configured in accordance with one or more embodiments. The system 700 includes a load balancer 702, web servers 704, 706, and 708, a file server 710, a MySQL database server 712, an Oracle database server 714, and storage modules 716 and 718.

According to various embodiments, the system 700 may be operable to provide services via a network such as the Internet. For instance, the system 700 may be operable to provide the services discussed with respect to the system 200 shown in FIG. 2 and/or the system 300 shown in FIG. 3. The system 700 may be operable to facilitate operations such as registering users, logging users onto the system, generating RFPs or proposals, reviewing RFPs or proposals, analyzing or processing RFPs or proposals, and/or managing or administering the system.

According to various embodiments, the system 700 may be hosted on a cloud-computing architecture. Cloud-computing providers allow the rapid deployment and hosting of a set of web applications. Further, applications hosted in a cloud environment are readily scalable as the applications and usage grows. Employing servers configured for cloud computing may facilitate a just-in-time infrastructure in which servers and instances may be self-provisioned based on factors such as the growth and demand of the applications.

According to various embodiments, the load balancer 702 may be operable to distribute the communications and/or computing load associated with the system among several web servers. As part of this process, the load balancer may receive requests via a network such as the Internet. Then, the load balancer may select a web server for handling the request. The load balancer may select a web server based on an amount of traffic being handled by the different web servers, a number of previous requests sent to a web server, a status condition reported by a web server, or any other criteria. In particular embodiments, after the load balancer directs a request to a particular web server, the web server may establish a communication session with the requesting machine. Then, further communications may be carried out directly between the requesting machine and the web server, bypassing the load balancer 702.

The system 700 includes the web servers 704-708. According to various embodiments, each web server may be a combination of software and hardware operable to receive requests via a network and transmit responses to at least some of those requests. For instance, a web server may receive a request to display a web page, such as a web page displaying a user interface for generating an RFP or a proposal. In order to respond to the requests, the web servers may communicate with other computing devices on the network, such as application servers and database servers. The web servers may employ proprietary and/or non-proprietary web server software, such as web server software available from Microsoft or from the Apache Software Foundation. Although the system 700 shown in FIG. 7 includes three web servers, various types and numbers of web servers may be employed. The types and numbers of web servers used may be strategically determined based on factors such as the amount and type of traffic handled by the web servers.

According to various embodiments, the file server 710 may be operable to store files that may be transmitted by the web servers in response to requests received via a network. For example, the file server 710 may store relatively static web pages that may be provided to client machines relatively unchanged. These static web pages may be cached for faster delivery to users. As another example, the file server 710 may store relatively dynamic web pages that may be modified based on dynamic information, such as information retrieved from the database servers 712 and 714.

According to various embodiments, the database servers 712 and 714 may handle requests to retrieve information stored in a database or to store information in a database. In particular embodiments, different types of database servers may be used for different types of tasks. For example, the MySQL database server 712 may be used for storing dynamic data related to the user interface. As another example, the Oracle database server 714 may be used for storing business data. The types and numbers of database servers used may be strategically determined based on the type of information stored in the databases and the types of relationships between the information.

According to various embodiments, the storage modules 716 and 718 may each include one or more storage devices configured for storing data. At least some of the data stored in the storage modules may be stored in accordance with a database format associated with a database server. For instance, the storage module 716 may store information in accordance with a MySQL database format and the storage module 718 may store information in accordance with the Oracle database format.

According to various embodiments, the modules and components shown in FIG. 7 may be arranged in various ways. For example, some modules or components may be located in different physical devices that communicate via a network. As another example, some modules or components may be located in the same physical machine. As discussed herein, the system 700 is an example of a system that may be used, and systems operable to perform similar operations may include various numbers and types of modules and components.

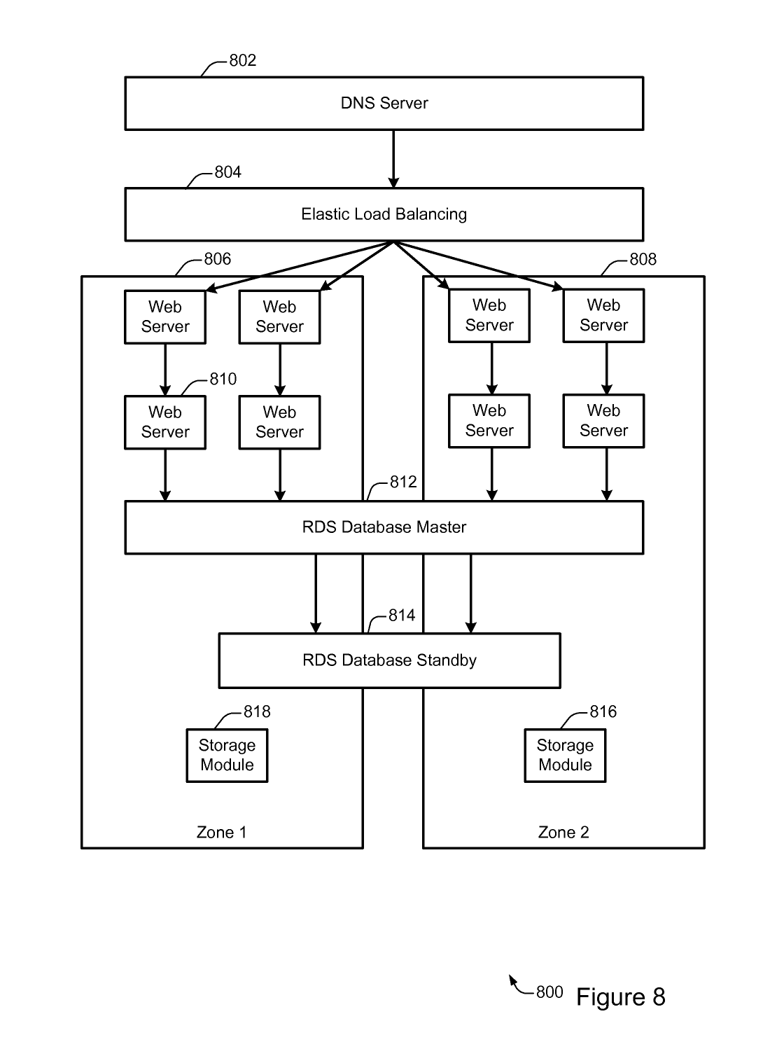

FIG. 8 shows a system 800 that may be used in accordance with techniques and mechanisms described herein. The system 800 shows a cloud-based infrastructure for providing the services related to generating RFPs and proposals. According to various embodiments, various providers of cloud-based infrastructures may be used. The system 802 includes a DNS server 802, a load balancer 804, a first group of web servers 806, a second group of web servers 808, a master database server 812, a standby database server 814, and storage modules 816 and 818.

According to various embodiments, the DNS server 802 may receive communications and identify a destination address for the communications. The load balancer 804 may select a web server for handling the traffic to help avoid or reduce network congestion. The web servers may be divided into different groups, such as groups based on geographic region, which may reduce network congestion as well as provide protection against failure at specific locations.

According to various embodiments, each web server may include a real and/or virtual server that can be configured based on various criteria, such as the computing needs of the application running on the server. Each web server may receive network communications, process the communications to prepare a response, perform any necessary communications with other servers such as application servers or database servers, and transmit the response. In some instances, some web servers may act as application servers. Application servers may server web pages as well or may provide information to other servers for serving web pages.

According to various embodiments, the master database server 812 may organize data via a relational database, with the standby database server 814 performing backup functions. In particular embodiments, the database servers may store information in two or more types of databases. For example, MySQL databases may be used to store information such as graphical user interface (GUI) data and web analytics data, while Oracle databases may be used to store information such as business data and domain data.

According to various embodiments, the data accessed via the database servers may be stored in the storage modules 816 and 818. The storage modules 816 and 818 may provide a durable, distributed mechanism for storing host files, database files, eternal files such as PDFs and images, and any other type of files.

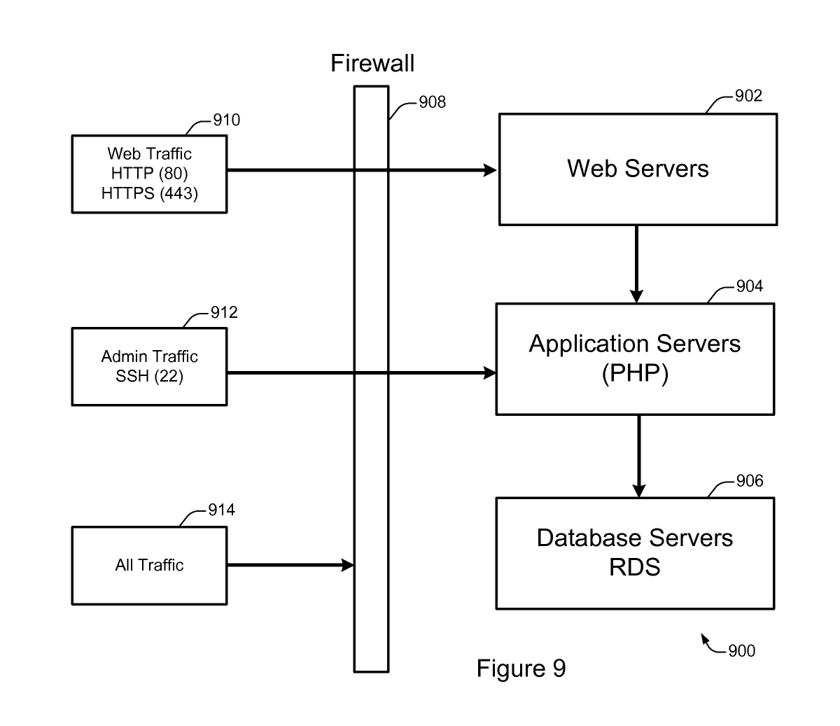

FIG. 9 shows a system 900 that may be used in accordance with techniques and mechanisms described herein. The system 900 shows the enforcement of a security protocol to protect against malicious or inadvertently dangerous network traffic. The system 900 includes one or more web servers 902, one or more application servers 904, and one or more database servers 906. Web traffic 910 and administration traffic 912 may be transmitted through a firewall 908. By routing traffic through a firewall, the servers such as web servers, application servers, and database servers may be protected.

According to various embodiments, the servers shown in FIG. 9 may be substantially similar to servers shown in other figures. For example, the web servers 902 may be substantially similar to the web servers 710 discussed with respect to FIG. 7. As another example, the database servers 906 may be substantially similar to the database servers 712 and 714. As yet another example, the application servers 904 may facilitate the type of operations discussed with respect to the systems 200 and 300 shown in FIGS. 2 and 3.

According to various embodiments, web traffic may include communications with client machines associated with users such as RFP and proposal authors. This web traffic may be transmitted via a protocol such as HTTP or HTTPS. The web traffic may be received at the web servers 902. In some instances, responses to requests transmitted via web traffic may be provided by a web server alone. For example, a request for a static web page such as a login page may in some instances be provided without accessing an application server. In some instances, providing responses to some requests may interact with an application server. For example, a request to edit an RFP based on user input may involve transmitting a message to an application server to perform the requested task. In some instances providing responses to some requests may involve transmitting a message to a database server. For example, a request to view an existing RFP may involve retrieving the RFP from a database.

According to various embodiments, administrative traffic may involve communications related to configuration, analysis, forecasting, or other administrative operations. Administrative traffic may be routed through the firewall 908 directly to the application servers 904.

According to various embodiments, the firewall 908 may include hardware and/or software. The firewall 908 may help to control incoming and/or outgoing network traffic. For example, the firewall 908 may analyze data packets and determine whether each packet should be allowed to pass through the firewall. The firewall 908 may function as a bridge between the internal network, which may be assumed to be secure and trusted, and an external network such as the internet, which is not assumed to be secure and trusted.

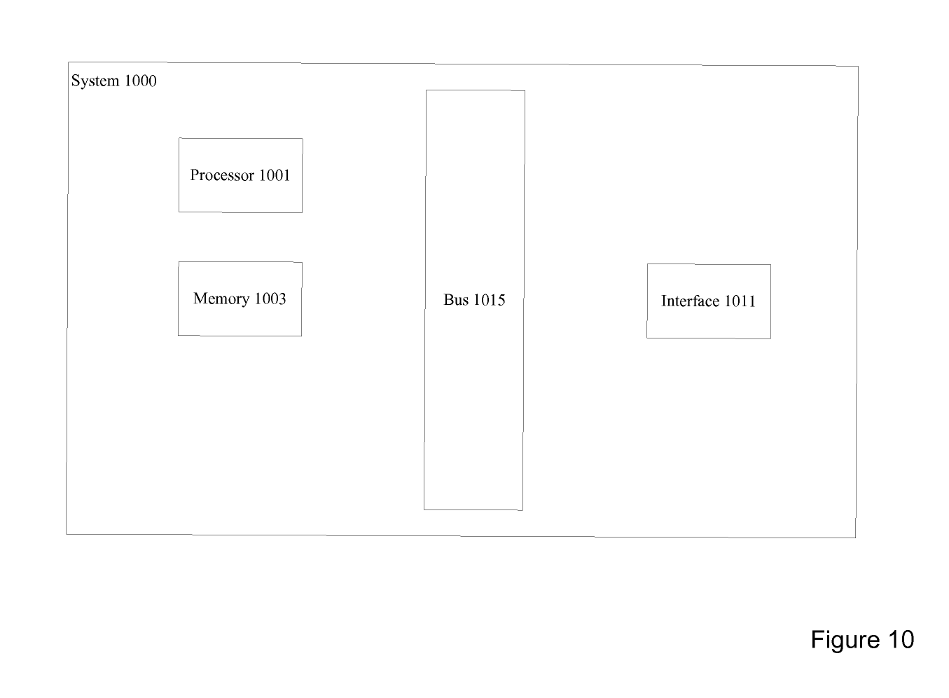

FIG. 10 illustrates one example of a server. According to particular embodiments, a system 1000 suitable for implementing particular embodiments of the present invention includes a processor 1001, a memory 1003, an interface 1011, and a bus 1015 (e.g., a PCI bus or other interconnection fabric) and operates as a streaming server. When acting under the control of appropriate software or firmware, the processor 1001 is responsible for modifying and transmitting live media data to a client. Various specially configured devices can also be used in place of a processor 1001 or in addition to processor 1001. The interface 1011 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 1000 is a server that transmits and receives communications via a network such as the Internet. In particular embodiments, the system 1000 may be configured as a database server, a web server, an application server, a file server, or any other server. The system 1000 may be in communication with client machines, such as desktop computers, laptop computers, mobile devices, smart televisions, or other servers.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices. Computer readable media encoded with the software/program code may be packaged with a compatible device or provided separately from other devices (e.g., via Internet download). Any such computer readable medium may reside on or within a single computer program product (e.g. a hard drive or an entire computer system), and may be present on or within different computer program products within a system or network. A computer system may include a monitor, printer, or other suitable display for providing any of the results mentioned herein to a user.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to communicate with a particular component or device and may instead include the component or device itself. A variety of configurations are possible.

1. A method comprising:
receiving, via a communications interface, user input for creating a document representing a request for proposals for a business action, the user input including information characterizing the business action;
based on the received user input, identifying suggested content to include in the document representing the request for proposals, the suggested content being identified via a processor, the suggested content describing the business action;
based on the received user input and the identified suggested content, creating the document representing the request for proposals, the document being created via the processor, the document identifying a business need and one or more criteria for responding to the request for proposals; and
storing the document representing the request for proposals on a storage medium.

2. The method recited in claim 1, wherein the document representing the request for proposals fits on a single page, and wherein creating the document representing the request for proposals comprises organizing and formatting the user input and the identified suggested content to fit on the single page.

3. The method recited in claim 1, wherein receiving the user input comprises receiving answers to one or more structured questions related to the request for proposals.

4. The method recited in claim 1, wherein the business action comprises an employment opportunity, and wherein the identified suggested content describes one or more objectives associated with the employment opportunity.

5. The method recited in claim 1, wherein the user input identifies an industry context associated with the business action, and wherein the suggested content includes information related to the identified industry context.

6. The method recited in claim 1, wherein creating the document representing the request for proposals comprises providing access to an interactive document editing system configured to create and update the document based on user interaction.

7. The method recited in claim 6, wherein the interactive document editing system is configured to present a preconfigured template for creating the document, the preconfigured template being selected based on the user input.

8. The method recited in claim 1, the method further comprising:
transmitting the document representing the request for proposals to one or more recipients via a network, each of the recipients being invited to review the request for proposals or to submit a proposal document in response to the request for proposals.

9. A system comprising:
a communications interface operable to receive user input for creating a document representing a request for proposals for a business action, the user input including information characterizing the business action;
a processor operable to:
identify suggested content to include in the document representing the request for proposals, the suggested content describing the business action and based on user input, and
operable to create the document representing the request for proposals, the document identifying a business need and one or more criteria for responding to the request for proposals; and
a storage medium operable to store the document representing the request for proposals.

10. The computing system recited in claim 9, wherein the document representing the request for proposals fits on a single page, and wherein creating the document representing the request for proposals comprises organizing and formatting the user input and the identified suggested content to fit on the single page.

11. The computing system recited in claim 9, wherein receiving the user input comprises receiving answers to one or more structured questions related to the request for proposals.

12. The computing system recited in claim 9, wherein the business action comprises an employment opportunity, and wherein the identified suggested content describes one or more objectives associated with the employment opportunity.

13. The computing system recited in claim 9, wherein the user input identifies an industry context associated with the business action, and wherein the suggested content includes information related to the identified industry context.

14. The computing system recited in claim 9, wherein creating the document representing the request for proposals comprises providing access to an interactive document editing system configured to create and update the document based on user interaction.

15. The computing system recited in claim 14, wherein the interactive document editing system is configured to present a preconfigured template for creating the document, the preconfigured template being selected based on the received user input.

16. One or more computer readable media having instructions stored thereon for performing a method, the method comprising:
receiving user input for creating a document representing a request for proposals for a business action, the user input including information characterizing the business action;
based on the received user input, identifying suggested content to include in the document representing the request for proposals, the suggested content describing the business action;
based on the received user input and the identified suggested content, creating the document representing the request for proposals, the document identifying a business need and one or more criteria for responding to the request for proposals; and
storing the request for proposals on a storage medium.

17. The one or more computer readable media recited in claim 16, wherein the document representing the request for proposals fits on a single page, and wherein creating the document representing the request for proposals comprises organizing and formatting the user input and the identified suggested content to fit on the single page.

18. The one or more computer readable media recited in claim 16, wherein receiving the user input comprises receiving answers to one or more structured questions related to the request for proposals.

19. The one or more computer readable media recited in claim 16, wherein the business action comprises an employment opportunity, and wherein the identified suggested content describes the responsibilities associated with the employment opportunity.

20. The one or more computer readable media recited in claim 16, wherein the user input identifies an industry context associated with the business action, and wherein the suggested content includes information related to the identified industry context.
